(19) United States
(12) Patent Application Publication
(10) Pub. No.: US 2020/0189956 A1
(43) Pub. Date: Jun. 18, 2020

(54) METHOD FOR BREAKING A SHEET OF GLASS

(71) Applicant: SAINT-GOBAIN GLASS FRANCE, Courbevoie (FR)

(72) Inventors: Ivan ULLIEL ROCHE, Compiegne (FR); Thierry DUMENIL, Margny les Compiegne (FR)

(73) Assignee: Saint-Gobain Glass France, Courbevoie (FR)

(21) Appl. No.: 16/614,900

(22) PCT Filed: May 18, 2018
(86) PCT No.: PCT/FR2018/051204

§ 371 Date: Nov. 19, 2019

(30) Foreign Application Priority Data
May 19, 2017 (FR) 1754463

(51) Int. Cl. C03B 33/03; C03B 33/033; C03B 33/04

(52) U.S. Cl. CPC C03B 33/03; C03B 33/04; C03B 33/033

(57) ABSTRACT

A method includes tracing a cutting line on the surface of the glass, using a cutting tool; positioning flat supporting bearing elements arranged to generate a pressing force on the cutting line; and breaking, using a local bearing system applied to the face opposite to, and facing, the cutting line, the local bearing elements being moved and applied along the cutting line, on the opposite face.

The present invention relates to the field of breaking a sheet of glass.

To carry out such breaking, two operations take place in sequence:
a preliminary operation of tracing one or more surface fissures on the surface of the glass, using, for example, a glazier's wheel or a laser; these fissures form lines on the contours of the shape, and this operation is called the “cutting” operation;
an operation of propagating the initial surface fissure through the thickness of the sheet of glass; this operation is called the “breaking” operation and is performed to separate the shape to be cut from the initial piece of glass, called the blank.

At present, there are two techniques for glass breaking, based on the complexity of the volume to be cut off:

For simple shapes with rectilinear edges not penetrating into the shape (with no concavity in the shape), a rectilinear inverse breaking technique may be used. This involves making a rectilinear cross cut, that is to say a cut from one edge to the other, and then putting the whole fissure into a state of extension by raising the sheet of glass along the whole length of the crack, using a bar or one or more point contacts.

However, this method cannot be used to cut complex shapes. For shapes with edges that are not rectilinear, the operation starts with a sheet of glass having greater dimensions than the shape to be cut. This sheet is called the blank, and is generally trapezoid in shape.

The starting point is a blank in the form of a square, a rectangle or a trapezium.

The contour of the shape to be cut is traced, using a glazier's wheel for example. Supplementary cuts in the shape of straight or curved segments are positioned on the periphery of the shape to be cut. These segments are called the additional lines, and allow the correct breaking of the part of the blank located outside the shape to be cut.

The breaking, in a number of steps, of the part of the blank located outside the shape to be cut results in the formation of various pieces called “offcuts” around the complex shape to be cut.

The shape to be cut is then separated from the offcuts of the blank.

In the case of the cutting of complex shapes described here, breaking takes place by a technique of locally subjecting the initial fissure to bending, by bearing on the offcut, or by gripping the offcut. The fissure is subjected to bending by a lever arm mechanism, by bearing on the glass sheet, outside the shape and at a limited number of points, on a hard or soft covering.

A glass sheet may be broken by subjecting an initial fissure of complex shape to bending, by subjecting the part outside the shape to be cut to bending.

The breaking may be carried out on a flexible mat. A force is applied to the offcut by bearing on it until the offcut is broken and separated.

The breaking may also be carried out on a hard mat. The glass sheet is placed in an overhanging position so that a force applied to the offcut by bearing or gripping enables the glass sheet to be deformed until it breaks.

However, these techniques have a number of drawbacks.

In the case of breaking on a hard mat, there is the loss of a sacrificial glass surface required for placing the glass in an overhanging position during breaking.

There may also be problems regarding the cutting quality of complex shapes, because, when a bearing force is applied to the offcut, it is usually impossible to create a bending stress at all points of the cutting line. This is notably the case for re-entrant shapes (concavities on the shape to be cut). In this case, the glass may be bent at the entry of the concave part, but as soon as there has been a small propagation of the fissure, and before the tool exerting the bearing force can be withdrawn, the stress field at the head of the fissure is modified by the geometry of the cutting line. The pure bending applied at the start of the concave part is rapidly transformed into a shear stress, causing scaling-off. In the case of shapes with a small radius, the fissure may propagate outside the initial cutting line and result in wastage.

Furthermore, this results in a limitation of the complex shapes that can be formed, particularly in the case of geometries having small concave radii of curvature (deeply incurved areas), where it is difficult to position a bearing point in a suitable way.

These difficulties make the breaking of concave shapes particularly complicated. If the radius of curvature is small, the adjustment of the positions of the bearing points and the forces at these points becomes complicated. In production, the breaking of these geometries is often sensitive to the slightest variation of operating parameters and may result in a high level of wastage. Furthermore, the tendency of the stress field at the end of the fissure to change from a pure bending mode to a shear mode is exacerbated when the thickness of the glass increases. Re-entrant shapes are thus considered to be very difficult to produce for 3.85 or 5 mm thick glass.

### SUMMARY OF THE INVENTION

One object of the invention is to provide a method for breaking a sheet of glass with improved cutting quality.

For this purpose, the invention proposes a method for breaking a sheet of glass comprising:
a step of tracing a cutting line on the surface of the glass, using a cutting tool;
a step of positioning flat supporting bearing means arranged to generate a pressing force on or around the cutting line and the area to be broken;
a step of breaking, using a local bearing means applied to the face opposite to, and facing, the cutting line, the local bearing means being moved and applied along the cutting line, on said opposite face.

The supporting bearing means may be a flat surface equipped with a covering whose hardness enables the area of deformation of the glass to be controlled and limited when the local bearing force is applied on said face opposite the cutting line.

This bearing surface may be flat as described below, but it could also be more point-like (see the diagram). The aim is still the same, namely to control the deformation of the glass during the breaking operation.

The means for containing and controlling the area of deformation relative to the local bearing force applied to said face opposite the cutting line may also be provided by using a vacuum to retain the face where the local bearing force is exerted.

The local bearing force applied to said face opposite the cutting line may be created by a pressure or a position.

This method has the advantage of enabling control to be achieved for better breaking quality by exerting a retaining force on the glass sheet in order to limit the propagation of the fissure. The control of the deformation of the glass is such that said glass sheet is arranged between the local breaking bearing means and the retaining bearing means, thereby enabling the bending of the glass sheet to be controlled and limited during the breaking step in order to control the fissure propagation areas locally, thus preventing the appearance of movement stresses/shear stresses that might cause scaling-off.

According to an example, the bearing means is a flat surface. This surface is pressed against the glass during the breaking operation (on the face on which the cutting line is made). The force of this pressing is controlled. The hardness of this surface is selected to permit the control described above.

According to an example, the bearing means comprise at least a pair of bodies acting as weights, said bodies being arranged on either side of the cutting line on the face on which the line is made.

According to an example, each body is a profiled element.

According to an example, each body is a stud.

According to an example, the studs of a pair are placed so that the line is equidistant from said studs.

According to an example, each stud of a pair is placed so as to form a rectilinear assembly with the studs of the contiguous pairs.

According to an example, the flat bearing means comprise at least a pair of suction elements, said suction elements being arranged on either side of the cutting line on the face on which the line is made.

According to an example, the suction elements are suction areas included in a suction table.

According to an example, said suction elements are suction cups.

According to an example, the suction cups of a pair are placed so that the line is equidistant from said suction cups.

According to an example, each stud of a pair is placed so as to form a rectilinear assembly with the suction cups of the contiguous pairs.

According to an example, the flat bearing means comprise a pair of studs or suction cups, and said breaking step also consists in moving the flat bearing means, said movement of the flat bearing means being identical to and simultaneous with the movement of the local bearing means.

### DESCRIPTION OF THE FIGURES

The invention will be more readily understood from a perusal of the following description, provided solely by way of non-limiting example, with reference to the following drawings:

FIGS. 1a and 1b are schematic views in vertical section of different steps of a method according to a particular embodiment of the invention;

FIGS. 2 to 7 are schematic views of a first embodiment of the invention and of its modes of application;

FIGS. 8 to 11 are schematic views of a second embodiment of the invention and of its modes of application;

FIG. 12 shows a variant of the different embodiments.

### DETAILED DESCRIPTION

A method according to a particular embodiment of the invention consists initially in a step of tracing a cutting line 2, that is to say a step of creating a fissure on a first face 4A of the glass sheet 4, followed by a step of turning over the glass sheet, for the purpose of a subsequent step of local bearing facing the fissure, on the face 4B opposite the first face. The traced cutting line is, for example, the contour of the complex shape to be cut, without additional lines.

It should be noted that, throughout the text, the term “complex shape” is taken to mean a curved line, or a sequence of lines of which some at least are not rectilinear, or rectilinear lines with changes of direction forming at least one concave part. Thus the method according to the invention allows a simple (rectilinear) or complex shape to be cut from a glass sheet.

The expression “two interlocking shapes” is taken to mean that a convex part of one extends into a concave part of the other; that is to say, the contours of the two shapes cannot be separated by a straight line.

The expression “two tangential shapes” is taken to mean that they have part of their contours in common.

It should also be noted that the glass sheet to be cut is flat.

The cutting line is traced, for example, by means of a glazer's wheel 6 or any other suitable cutting instrument, such as a laser. The cutting line 2 is a fissure intended to allow breaking along this line in the breaking step. This is therefore a partial cut, that is to say a cut through only a part of the thickness of the glass sheet. This is taken to be the meaning of “cutting line” throughout the text.

With this method, as explained above, some or all of the additional lines used in the prior art method may be eliminated. This is because the additional lines may be needed only to open the contour to extract the shape, rather than to facilitate the breaking of complex shapes.

The first face 4A of the glass sheet 4, on which the cutting line 2 has been made, is made to bear on a flat bearing surface 8. This is, for example, a flexible mat. The deformability of the flat bearing surface 8 is chosen so as to control the stress field applied by the local bearing means. By controlling the stress field, it is possible to control the fissure propagation length. The aim is for the fissure to propagate to a predetermined length, depending on the shape to be cut. The length chosen for the fissure will decrease as the local radius of curvature is reduced. If the fissure propagates too rapidly, a less deformable surface or a lower bearing pressure must be chosen. If the fissure propagates too slowly, a more deformable surface or a higher bearing pressure must be chosen.

For a standard soda-lime-silica glass sheet of the Planilux type with a thickness of 3.15 mm, the parameters were as follows:

Cutting Parameters:
Wheel: angle 150°, width=1 mm, diameter: 5 mm
Wheel movement speed: 100 m/min
Force exerted on the glass=50 N
Penetration of wheel into the glass: 4/100 mm
Glass thickness: 3.15 mm
Inverse breaking parameters:
Breaking tool: wheel type, diameter: 5 mm, width: 1 mm
Tool movement speed: 30 m/min
Force exerted on the glass=70 N
Hardness of covering of flat bearing means: felt mat, hardness: 45-52 Shore

The local bearing means 10 is, for example, a ball of any suitable type, or another local bearing means of any suitable type, for example a tracing wheel, preferably a toroidal tracing wheel. The ball has, for example, a diameter of 1 mm. In a variant, any suitable diameter may be chosen, notably up to 10 or even 20 mm.

The chosen local bearing means 10 is preferably rigid, being made of steel or suitable plastic material, for example.

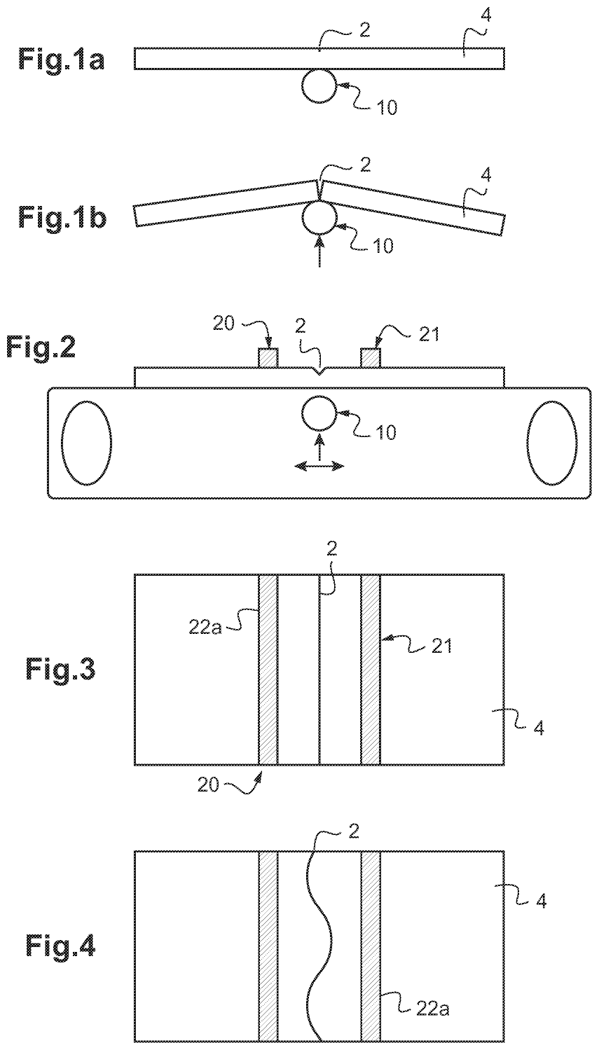

The local bearing means 10 is moved along the cutting line, along the whole length of the cutting line, preferably while exerting a continuous bearing force, for example a force of constant intensity as shown in FIGS. 1a and 1b. In a variant, however, the bearing is continuous but of variable intensity, the intensity being chosen, for example, on the basis of the local radius of curvature of the shape to be cut, and being supplemented, for example, with a periodic variation of intensity, that is to say a vibrating bearing. In a further variant, the bearing on the glass sheet takes place in a discontinuous way.

The local bearing means is moved relative to the glass sheet. It should be noted, however, that in a variant it is the glass sheet that is moved, or both elements. As a general rule, there is a relative movement of the local bearing means 10 with respect to the glass sheet 4.

The flat bearing surface 8 is, for example, formed by a table, and thus by a continuous flat surface. In a variant, however, the flat bearing surface 8 could be discontinuous. It could, for example, consist of a plurality of flat bearing surfaces formed by portions of tables, for example. What is important is that a flat bearing surface 8, that is to say a bearing surface at least twice as wide as the bearing force exerted by the local bearing means, is provided facing the local bearing means 10, so as to achieve a clean break.

It should also be noted that the step of turning over is optional. For example, a suction table may be used to raise the glass sheet 4 and thus apply the local bearing means 10 from underneath, the first face 4A of the glass sheet then being placed against the suction table.

According to the invention, the breaking method further comprises a step of positioning flat bearing means 20. These flat bearing means 20 may take a number of forms.

These flat bearing means 20 are arranged to generate a pressure force on the face of the glass on which the cutting line 2 is arranged. This pressure force is applied to the glass at the position of the cutting line.

These flat bearing means 20 have the function of exerting a pressure stress/force on the glass sheet 4 in order to control the propagation of the cut. This stress/force exerted on the sheet at the cutting line enables the propagation of the fissure to be controlled. This is because this pressure force is applied so that said glass sheet 4 is arranged between the local bearing means 10 and the flat bearing means 20. This arrangement limits, or even eliminates, the bending of the glass sheet 4 in the breaking step, so as to prevent the appearance of shear stresses that might create scaling-off.

This control of the breaking is provided by the pressure stress of the flat bearing means 20.

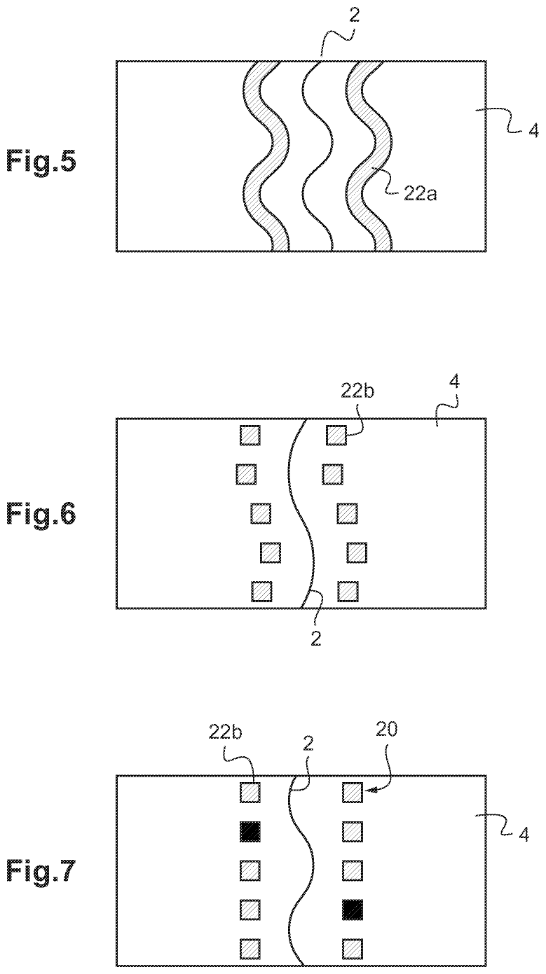

In a first embodiment shown in FIG. 2, the flat bearing means 20 comprise at least two weights 21. These weights 21 are basic bodies made of a metallic, mineral or other material. These bodies are positioned on the first face 4A of the glass sheet 4 on which the cutting line 2 has been made. This arrangement enables said bodies to exert a force on said glass sheet 4.

In a first mode of application shown in FIG. 3, the flat bearing means 20 comprise two bodies 21 acting as weights. These bodies are arranged in the form of a bar or profiled element 22a. These profiled elements 22a are then positioned on either side of a portion of the cutting line. According to a first example, the profiled elements 22a are rectilinear.

If the portion is rectilinear as shown in FIG. 3, the rectilinear profiled elements 22a are then positioned parallel to said portion.

If the portion is curved, the rectilinear profiled elements 22a are then positioned parallel to the tangent of said portion.

If the portion is sinusoidal as shown in FIG. 4, the rectilinear profiled elements 22a are then positioned parallel to the director axis of said portion. The director axis is taken to be the axis passing through the mean value.

According to a second example shown in FIG. 5, the profiled elements 22a have a similar shape to the cutting line, so that, if this line is curved, the profiled elements 22a will be curved with the same curvature, and, if the line is sinusoidal, the profiled elements 22a will be sinusoidal in the form of the same sinusoid. Advantageously, this second example enables the profiled elements 22a to be placed at the same distance from the line in non-rectilinear portions, so as not to unbalance the breaking.

In a second mode of application shown in FIG. 6, the flat bearing means 20 comprise a plurality of pairs of bodies 21 acting as weights. These bodies are made so as to take the form of a stud 22b or a cylindrical part, for example. These studs 22b are then positioned on either side of a portion of the cutting line 2.

If the portion is rectilinear, the studs 22b are then positioned, in pairs, in such a way that the line 2 is equidistant from the two studs 22b in the same pair. The pairs of studs 22b are then regularly distributed along the portion.

If the portion is rectilinear, the studs 22b are advantageously positioned, in pairs, in such a way that the line 2 is equidistant from the two studs in the same pair, as shown in FIG. 6. The pairs of studs 22b are then regularly distributed along the portion. However, in the case of a sinusoidal line, the studs 22b may be positioned so that all the studs 22b on each side of the sinusoid are aligned in a rectilinear way, as shown in FIG. 7. This arrangement is possible because this distribution based on the sinusoidal line enables a uniform stress to be applied along the breaking line 2.

In a second embodiment, the flat bearing means 20 comprise suction elements 23. These suction elements 23 are apparatuses or devices comprising at least a pump and a suction mouth. These suction elements 23 are positioned on the face 4B opposite the first face of the glass sheet 4. This arrangement enables said suction elements 23 to exert a tensile force on said glass sheet 4.

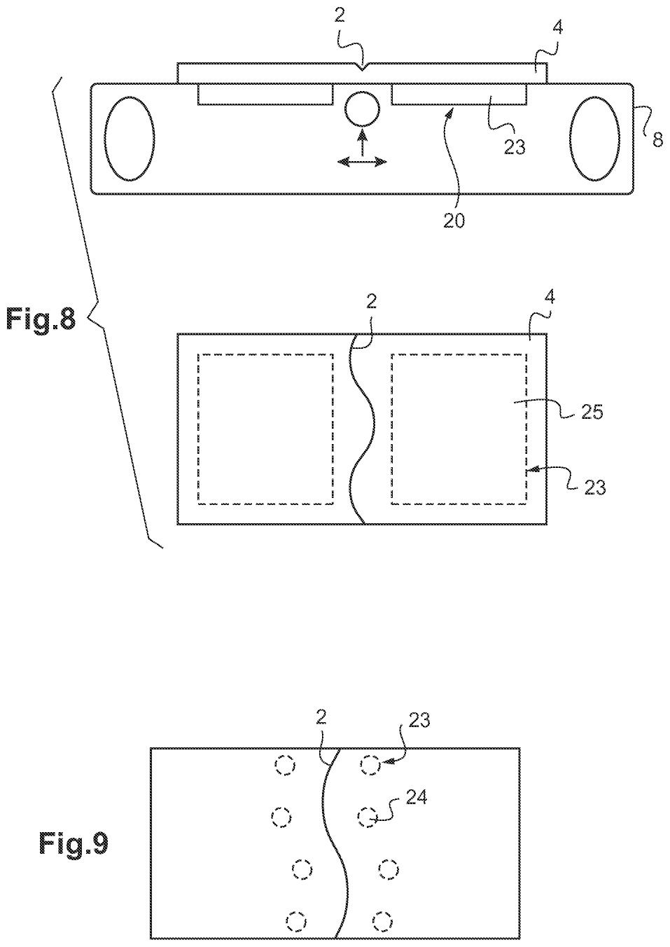

In a first mode of application shown in FIG. 8, the suction elements 23 comprise a suction table. This table consists of a cutting table, that is to say a table allowing the relative movement of the local bearing means 10 with respect to the glass sheet 4, whose suction elements 23 take the form of at least two suction areas 25, each taking the form of a plate having at least one opening, or preferably a plurality thereof. These plates are connected to a pump via a line connecting the pump to the openings in said plate in order to produce the suction action. These two suction areas 25 are arranged to allow the local bearing means 10 to circulate between them. Thus the suction areas 25 are capable of sucking the glass sheet on either side of the breaking line.

In a second mode of application shown in FIG. 9, the suction elements 23 comprise a plurality of suction cups 24. These suction cups 24, preferably arranged in pairs, are made so as to take the form of a stud or a cylindrical part, for example. These suction cups 24 are then positioned on either side of a portion of the cutting line. Each suction cup 24 is connected to a suction system, which may be provided individually for each cup or may be common to all the suction cups 24, to allow suction to take place.

If the portion is rectilinear, the suction cups 24 are then positioned, in pairs, in such a way that the line is equidistant from the two studs in the same pair, as shown in FIG. 10. The pairs of suction cups 24 are then regularly distributed along the portion.

If the portion is not rectilinear, the suction cups 24 are advantageously positioned, in pairs, in such a way that the line is equidistant from the two suction cups 24 in the same pair, as shown in FIG. 3. The pairs of suction cups 24 are then regularly distributed along the portion. However, in the case of a sinusoidal line, the suction cups 24 may be positioned so that all the suction cups 24 on each side of the sinusoid are aligned in a rectilinear way, as shown in FIG. 11. This arrangement is possible because this distribution based on the sinusoidal line 2 enables a uniform stress to be applied along the breaking line.

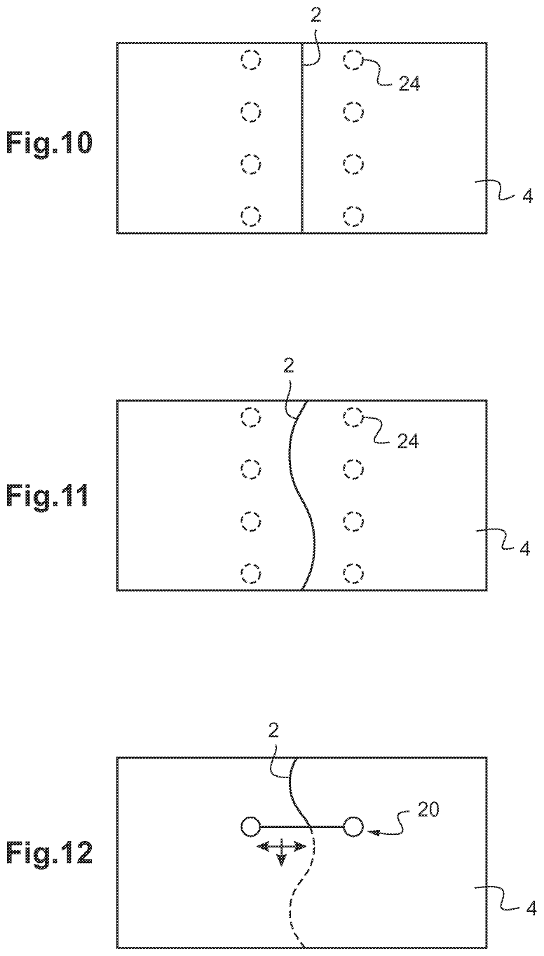

In a variant of the different embodiments, it is possible to have movable flat bearing means 20. For this purpose, the flat bearing means comprise two suction cups 24 or two bodies 21 acting as weights. These two suction cups 24 or bodies 21 acting as weights are arranged to be fixed to one another with respect to movement. This signifies that the movement of one of the bodies acting as weights or of one of the cups automatically causes an identical movement of the other body acting as a weight, or of the other cup, as shown in FIG. 12.

Thus the breaking step may take place with the simultaneous movement of the local bearing means 10 and the flat bearing means. This breaking step therefore consists in, firstly, arranging the local bearing means 10 and the flat bearing means facing one another with respect to the glass sheet. In the case of suction cups 24, the suction is then initiated.

Secondly, pressure is exerted on the local bearing means so that the latter presses the glass sheet at the position of the breaking line and can break the glass sheet.

Thirdly, the local bearing means and the flat bearing means move simultaneously and in the same way. Clearly, therefore, the movements of the local bearing means and the flat bearing means are produced in such a way that the local bearing means and the flat bearing means are constantly facing one another. This simultaneous movement may advantageously exert the pressure solely at the place where it is required for breaking.

Evidently, the present invention is not limited to the illustrated example, but may be varied and modified in different ways which will be apparent to those skilled in the art.

1. A method for breaking a sheet of glass, comprising:
tracing a cutting line on the surface of the glass, using a cutting tool;
positioning flat supporting bearing means arranged to generate a pressing force on the cutting line; and
breaking, using a local bearing means applied to the face opposite to, and facing, the cutting line, the local bearing means being moved and applied along the cutting line, on said opposite face.

2. The breaking method as claimed in claim 1, wherein the flat bearing means comprise at least a pair of bodies acting as weights, said bodies being arranged on either side of the cutting line on the face on which the cutting line is made.

3. The breaking method as claimed in claim 2, wherein each body is a profiled element.

4. The breaking method as claimed in claim 2, wherein each body is a stud.

5. The breaking method as claimed in claim 4, wherein the studs of a pair are placed so that the cutting line is equidistant from said studs.

6. The breaking method as claimed in claim 4, wherein each stud of a pair is placed so as to form a rectilinear assembly with the studs of the contiguous pairs.

7. The breaking method as claimed in claim 1, wherein the flat bearing means comprise at least a pair of suction elements, said suction elements being arranged on either side of the cutting line on the face opposite that on which the line is made.

8. The breaking method as claimed in claim 7, wherein the suction elements are suction areas included in a suction table.

9. The breaking method as claimed in claim 7, wherein said suction elements are suction cups.

10. The breaking method as claimed in claim 9, wherein the suction cups of a pair are placed so that the cutting line is equidistant from said suction cups.

11. The breaking method as claimed in claim 9, wherein each suction cup of a pair is placed so as to form a rectilinear assembly with the suction cups of the contiguous pairs.

12. The breaking method as claimed in claim 4, wherein the flat bearing means comprise a pair of studs or suction cups, and said breaking includes moving the flat bearing means, said movement of the flat bearing means being identical to and simultaneous with the movement of the local bearing means.
